(19) United States
(12) Patent Application Publication
(10) Pub. No.: US 2018/0067956 A1
(43) Pub. Date: Mar. 8, 2018

(54) DATA RECORDING METHOD

(71) Applicant: Panasonic Intellectual Property Management Co., Ltd., Osaka (JP)

(72) Inventor: Masahiro INAGAKI, Osaka (JP)

(21) Appl. No.: 15/681,355

(22) Filed: Aug. 19, 2017

(30) Foreign Application Priority Data
Sep. 8, 2016 (JP) 2016-175123

(51) Int. Cl. G06F 17/30

(52) U.S. Cl. CPC G06F 17/30091

(57) ABSTRACT

A data recording method includes the steps of: selecting a first file from a plurality of input files and storing the data of the first file into a pack file created based on a file system on a recording medium; generating a management file and storing management information of the first file on the pack file into the management file; and recording both the pack file containing the data of the first file and the management file containing the management information of the first file into the recording medium.

### BACKGROUND

### 1. Technical Field

The present disclosure relates to a method for recording data into a recording medium.

### 2. Description of the Related Art

PTL 1 discloses an optical disc system according to which data to be written is stored into temporary storage, and when its length satisfies predetermined requirements, the data is actually recorded into a write-once optical disc. PTL 1 says that this system makes it possible to record even small amount of data into the write-once optical disc.

PTL 2 discloses an optical disc recording device according to which data to be recorded into an optical disc is previously compressed and stored into temporary storage. The recording device controls the data recording into the optical disc in accordance with the amount of data stored in the temporary storage. PTL 2 says that this recording device has low power consumption.

### CITATION LIST

### Patent Literature

PTL 1: Japanese Unexamined Utility Model Application No. H04-49356

PTL 2: Japanese Unexamined Patent Application Publication No. 2000-11517

### SUMMARY

When data is recorded into a recording medium on a file-by-file basis using a file system, not only the file data itself but also data to manage the file (file system management information) are recorded into the recording device. Therefore, when there are a lot of files to be recorded into the recording medium, both the file data itself and the file system management information for each file are to be recorded, possible causing a decrease in the speed of data recording. This is particularly likely when a large number of small data files are recorded.

To overcome this issue, the present disclosure provides a method for recording data efficiently into a recording medium using a file system.

The data recording method according to the present disclosure includes the steps of: selecting a first file from a plurality of input files and storing the data of the first file into a pack file created based on a file system on a recording medium; generating a management file and storing management information of the first file on the pack file into the management file; and recording both the pack file containing the data of the first file and the management file containing the management information of the first file into the recording medium.

The data recording method according to the present disclosure achieves efficient recording of data into a recording medium.

### BRIEF DESCRIPTION OF THE DRAWINGS

FIG. 1 is a schematic diagram of a data recording system according to an exemplary embodiment;

FIGS. 2A and 2B are schematic diagrams showing how data is recorded into a recording medium in the exemplary embodiment;

FIG. 3 is a schematic diagram showing the size of a pack file in the exemplary embodiment;

FIG. 4 is a flowchart of generating a pack file in the exemplary embodiment;

FIG. 5 shows pack files generated in the same directory structure as input files in the exemplary embodiment; and

FIG. 6 shows pack files generated directly under the root directory in the exemplary embodiment.

### DETAILED DESCRIPTION

Exemplary embodiments will be described in detail as follows with reference to the accompanying drawings. In the exemplary embodiments, the description of well-known matter and of substantially the same configuration as described earlier may be omitted to avoid redundancy and help those skilled in the art understand them easily.

Note that the attached drawings and the following description are provided to make those skilled in the art fully understand the present disclosure, and are not intended to limit the claimed subject matter.

### First Exemplary Embodiment

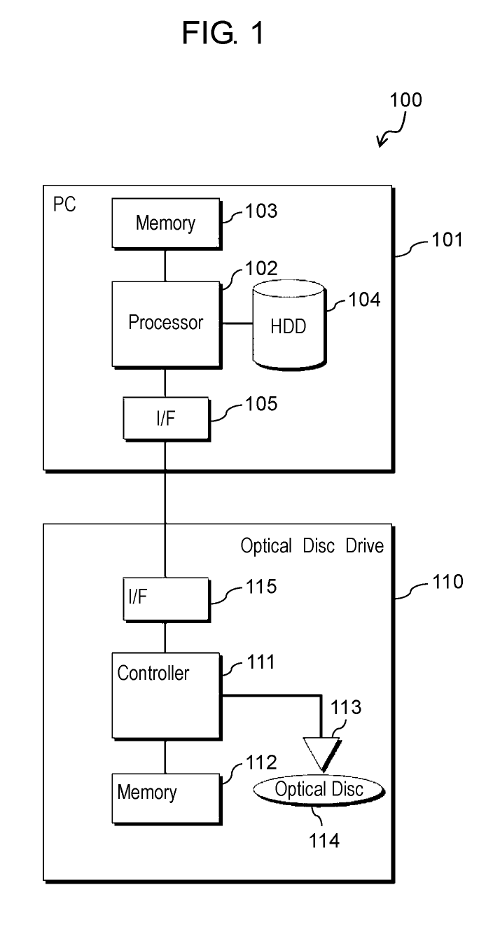

FIG. 1 is a schematic diagram of the data recording system according to the present exemplary embodiment. Data recording system 100 includes personal computer (hereinafter, PC) 101 and optical disc drive 110.

PC 101 controls optical disc drive 110. More specifically, PC 101 instructs optical disc drive 110 to read or write data. PC 101 is just an example used in the present exemplary embodiment, and the scope of the present disclosure is not limited to this.

PC 101 includes processor 102, memory 103, hard disk 104, and interface 105.

Processor 102 controls PC 101 as a whole, and also controls optical disc drive 110. To achieve the control, processor 102 operates software (execution programs) stored in memory 103, hard disk 104, or other storage devices. Specific examples of processor 102 include a central processing unit (CPU), a programmable logic device (PLD), and a digital signal processor (DSP).

Memory 103 is used to hold programs as the software to operate processor 102. Memory 103 is also used as temporary data storage used when processor 102 executes a program. If the size of the temporarily stored data is larger than the capacity of memory 103, hard disk 104 can temporarily hold data in the same manner as memory 103 does.

Hard disk 104 is used as storage for large volumes of data or long-term data. Disk 104 is just as an example used in the present exemplary embodiment, and the scope of the present disclosure is not limited to this. Disk 104 can be replaced by a solid state drive (SSD) with semiconductor memory, or other storage devices with a storage module. In the present exemplary embodiment, hard disk 104 is used as a storage place for file data to be recorded into optical disc 114, but the scope of the present disclosure is not limited to this. For example, file data may be supplied from another computer, instead of using hard disk 104.

Interface 105 enables PC 101 to communicate with external devices. Specific examples of interface 105 include universal serial bus (USB), serial attached SCSI (SAS), wired Ethernet (registered trademark), and wireless WiFi connections.

Optical disc drive 110 can read/write data from/into optical disc 114 under the instruction of PC 101. Optical disc drive 110 includes controller 111, memory 112, optical head 113, optical disc 114, and interface 115.

Controller 111 controls optical disc drive 110 as a whole. To achieve the control, controller 111 operates software (execution programs) stored in memory 112, or other storage devices. Specific examples of controller 111 include a CPU, a PLD, a DSP, just like processor 102.

Memory 112 is used to hold programs as the software to operate controller 111. Memory 112 is also used as temporary data storage used when controller 111 executes a program.

When reading/writing data from/into optical disc 114, optical head 113 emits light to disc 114 and receives reflected light from disc 114. Optical head 113 converts information received from controller 111 into light, and sends the light to optical disc 114, and transmits the light received from disc 114 as data to controller 111. Disc 114 is a transportable data recording medium. Disc 114 is just an example of the recording medium used in the present exemplary embodiment, and the scope of the present disclosure is not limited to this.

Interface 115 enables optical disc drive 110 (controller 111) to communicate with external devices. Interface 115 has the same specification and operates in the same manner as interface 105 because they are to be coupled to each other. Similar to interface 105, interface 115 can be either wired or wireless.

In data recording system 100 shown in FIG. 1, PC 101 and optical disc drive 110 are separate devices; however, the scope of the present disclosure is not limited to this configuration. For example, optical disc drive 110 may be one of the modules of PC 101. Alternatively, system 100 may be in another form.

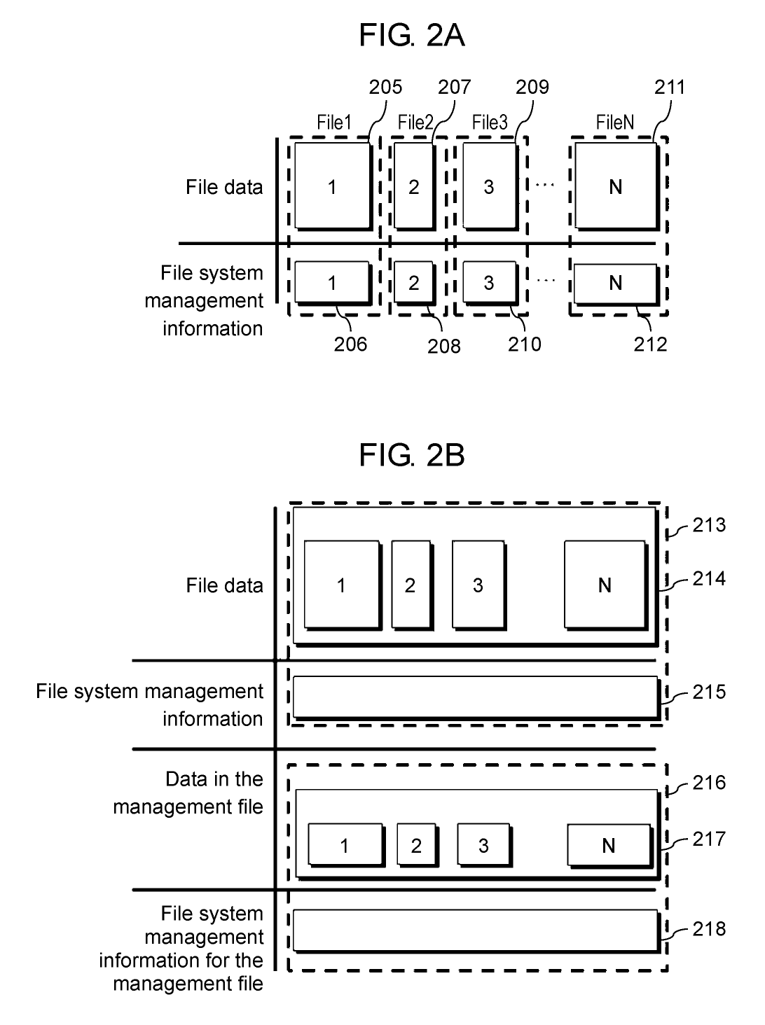

FIGS. 2A and 2B are schematic diagrams showing how data is recorded into a recording medium in the present exemplary embodiment. In PC 101, processor 102 reads files 1, 2, 3, and N shown in FIG. 2A as input files from hard disk 104. When reading these input files 1 to N from hard disk 104, processor 102 acquires data 205, 207, 209, and 211 of files 1, 2, 3, and N, respectively, as well as file system management information 206, 208, 210, and 212 for files 1, 2, 3, and N, respectively.

If processor 102 records the read input files 1 to N intact into optical disc 114, data 205 to 211 of input files 1 to N as well as file system management information 206 to 212 for these files are recorded into disc 114. As a result, disc 114 is loaded with a collection of 2N data. If these data are recorded in different locations on disc 114, controller 111 changes (adjusts) the position of optical head 113 on disc 114 every time data is recorded. The process of changing the position of optical head 113 takes time and decreases the speed of data recording.

If disc 114 is a write-once recording medium, every time a piece of file system management information 206 to 212 for files 1 to N, respectively, is recorded, directory information related to these files is to be updated. Therefore, recording file data intact into disc 114 may often waste the recording area.

The term “file system management information” means information used when data is recorded on a file-by-file basis using a file system. The file system management information contains, for example, the name of each file, the position on the recording medium at which to start recording the file, the physical sizes of the file on the recording medium, the logical sizes of the file, and the position in the directory tree at which the file is stored.

According to the present exemplary embodiment, before instructing optical disc drive 110 to write data into optical disc 114, processor 102 converts the data into a preferred data content. FIG. 2B shows the data converted by processor 102. More specifically, processor 102 stores data 205 to 211 of files 1 to N as data 214 of a single pack file 213 shown in FIG. 2B. Thus, processor 102 combines the data of a plurality of input files into a single pack file, thereby combining a plurality of pieces of file system management information into the single pack file 213.

As shown in FIG. 2B, data 214 of pack file 213 consists of data 205 to 211 of input files 1 to N, respectively.

However, if N pieces of data of files 1 to N were recorded as one pack file 213 into optical disc 114, it would be inconvenient to read only a specific one of the files. To solve this, processor 102 records information to manage and distinguish the data of files 1 to N on pack file 213 into a different file. More specifically, the different file is management file 216 shown in FIG. 2B.

Management file 216 holds information to distinguish individual input files stored in the single pack file 213. Management file 216 (corresponding to data 217) contains information such as the number of files stored in pack file 213, the names of these files, and the offset position on data 214 of pack file 213 which indicates the head position of each file from which each file starts to be recorded. Alternatively, management file 216 may be a file of the database for centralized management of the above-described information.

Processor 102 converts data 205 to 211 of files 1 to N, which are input files read from hard disk 104, into the single pack file 213. Processor 102 instructs optical disc drive 110 to record pack file 213 generated on memory 103 into optical disc 114. As a result, optical disc 114 is loaded with a collection of four pieces of data: data 214 of pack file 213, file system management information 215 for pack file 213, data 217 of management file 216, and file system management information 218 for management file 216.

In short, the more files are stored in the single pack file 213, the more efficiently data is recorded into optical disc 114.

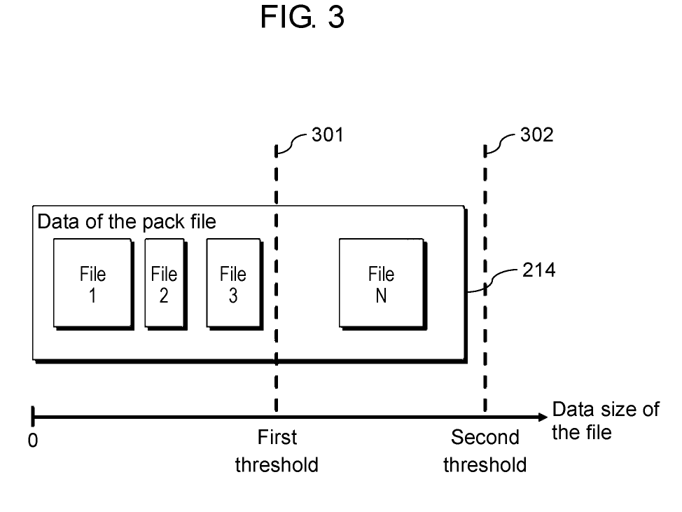

The present exemplary embodiment imposes some conditions on the size of pack file 213. FIG. 3 is a schematic diagram showing the size of pack file 213 in the present exemplary embodiment. Processor 102 uses first threshold 301 and second threshold 302 in generating data 217 of management file 216.

First threshold 301 is previously set by the user. It is preferable that the user can select first threshold 301 from some candidates. More specifically, first threshold 301 can be a predetermined value such as 10, 20, 50, 100, 200, or 500 megabytes. Alternatively, first threshold 301 may be determined based on the capacity of optical disc 114. The larger the capacity of the disk, the larger first threshold 301 can be. Still alternatively, it is possible to combine the above conditions. For example, first threshold 301 determined based on the capacity of disc 114 can be first suggested to the user as a recommended value, and later the user can change the value to another value.

Meanwhile, second threshold 302 is determined based on first threshold 301. For example, second threshold 302 can be substantially twice the first threshold 301. Alternatively, second threshold 302 can be determined based on a combination of different conditions, such as a combination of the value of first threshold 301 and a property of optical disc 114 as a recording medium, or a combination of the value of first threshold 301 and the type of main data to be recorded into optical disc 114.

Specific examples of using first and second thresholds 301 and 302 are as follows. Processor 102 generates pack file 213 having data 214 of not less than first threshold 301 and less than second threshold 302. In other words, when data 214 of pack file 213 is less than first threshold 301, processor 102 increases the file size by adding a new file. In contrast, when data 214 of pack file 213 becomes equal to or greater than first threshold 301, processor 102 stops adding new files to pack file 213. The addition of new files by processor 102 to pack file 213 is performed on a file-by-file basis. As a result of this process, processor 102 generates pack file 213 with data size of not less than first threshold 301 and less than second threshold 302.

By providing first threshold 301 and second threshold 302 as described above, files to be recorded into optical disc 114 have approximately the same data size, facilitating data recording into optical disc 114.

If a file is large enough to make data 214 of pack file 213 not less than the first threshold, processor 102 can generate data 214 with this file alone.

If data 214 of pack file 213 becomes equal to or greater than second threshold 302 when a new file is added to it, the addition of the new file is cancelled. When second threshold 302 is substantially twice first threshold 301, the new file may have data of equal to or greater than first threshold 301. In such a case, processor 102 can generate a different pack file with the new file alone.

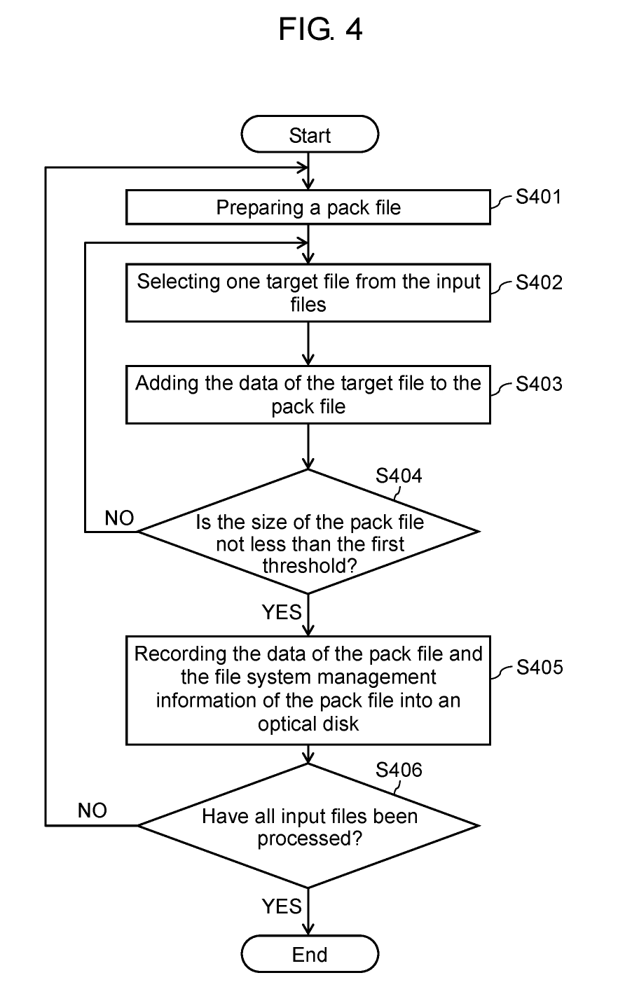

FIG. 4 is a flowchart of generating pack file 213 in the present exemplary embodiment.

In Step S401, processor 102 prepares pack file 213 to be used to record data into optical disc 114. The term “prepare” used here includes allocating a temporary area to be used to generate pack file 213 on memory 103.

In Step S402, processor 102 selects one file from specified input files in hard disk 104.

In Step S403, processor 102 duplicates the data of the selected file in the temporary area on memory 103 that is allocated for pack file 213. If the temporary area for pack file 213 already contains the data of another file, the data of the selected file is added to the end.

In Step S404, processor 102 determines whether data 214 of pack file 213 stored in the temporary area allocated on memory 103 is not less than first threshold 301. If data 214 is equal to or greater than first threshold 301, the process goes to Step S405. In contrast, if data 214 is less than first threshold 301, the process goes to Step S402 where another file is selected from input files.

In Step S405, processor 102 records data 214 and file system management information 215 for pack file 213 into optical disc 114 via controller 111. Processor 102 further records data 217 and file system management information 218 for management file 216 to optical disc 114.

In Step S406, processor 102 determines whether all input files to be recorded into optical disc 114 have been recorded. When the recording of all the files is completed, processor 102 terminates the process; otherwise, the process returns to Step S401 where a new pack file is subjected to the subsequent process.

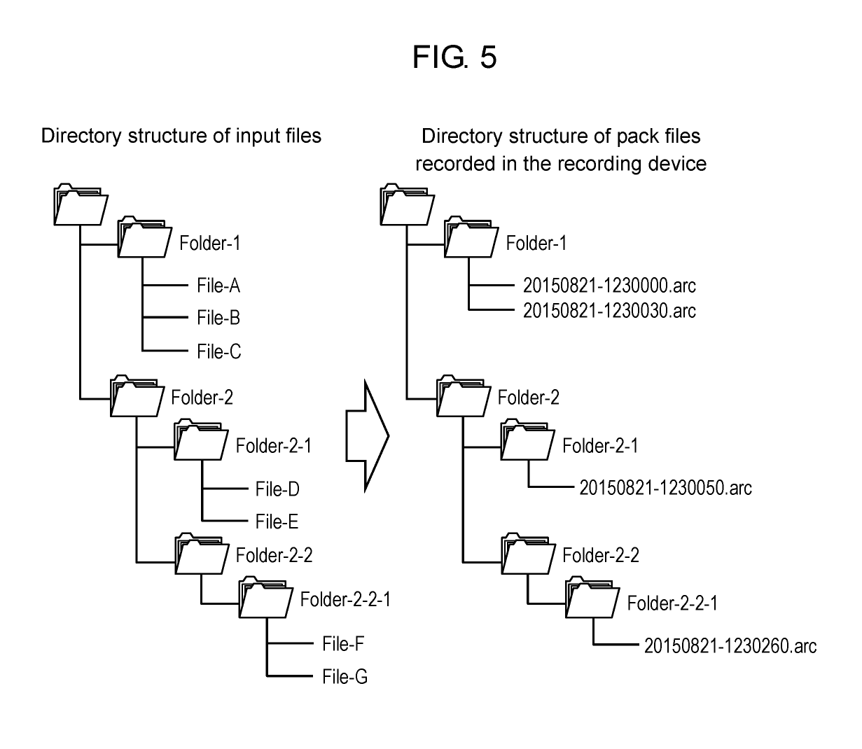

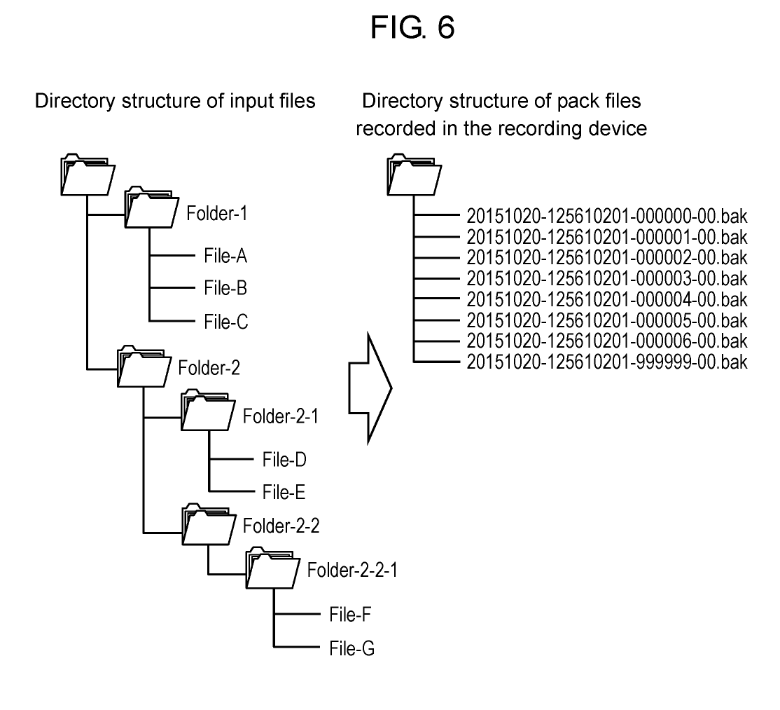

Management of directory information in generating pack files will now be described with reference to FIGS. 5 and 6. FIG. 5 shows pack files generated in the same directory structure as input files in the exemplary embodiment. FIG. 6 shows pack files generated directly under the root directory in the exemplary embodiment.

In the example of FIG. 5, the directory/folder structure of pack files to be recorded into optical disc 114 is identical to that of the data files to be input. In other words, the directory structure of hard disk 104 is duplicated in optical disc 114, and pack files containing the input files are placed under the respective directories. More specifically, for example, File-A, File-B, and File-C under Folder-1 are stored in pack files “20150821-1230000.arc” and “20150821-1230030.arc”, which are also placed under Folder-1.

In this case, the directory information is stored in the directory entries corresponding to the respective file systems on optical disc 114. In short, the directory information managed by the file systems is used intact.

In the example of FIG. 6, all pack files to be recorded into optical disc 114 are placed under the root directory. In this case, the information on the directories in which the input files in the respective pack files are originally placed is stored in management file 216 described in FIG. 2B as the information corresponding to the respective files. When a pack file is read, the management file is also read, so as to distinguish the original directories of the input files.

As described above, according to the data recording method of the present disclosure, one file is selected from one or more input files. The data of the selected file is duplicated in (added to) a pack file. Every time a file is added, the data size of the pack file at that moment is compared with a first threshold. If the data size of the pack file is less than the first threshold, a new input file is selected and its data is duplicated in (added to) the pack file. Assume that as a result of repeating this process, the data size of the pack file becomes equal to or greater than the first threshold. In this case, the data of the pack file and the file system management information for the pack file, which is in conformity with the rules of the file system on the recording medium, are recorded into the recording medium.

According to the data recording method of the present disclosure, a plurality of input files can be combined into one pack file. As a result, the respective pieces of file system management information for these files are combined into a single piece of file system management information. This reduces the time to record data into a recording medium.

If the recording medium is of a write-once type, such as a CD-R, a DVD-R, or a BD-R, the information that is under the management of the file system and is updated every time file data is recorded can be updated less frequently. This prevents wasting of the recording area.

### Modified Example of First Exemplary Embodiment

The first exemplary embodiment has been described as an example of the implementation of the present disclosure. However, the techniques of the present disclosure are not limited to this embodiment and are applicable to other exemplary embodiments provided with modification, replacement, addition, omission, etc. Furthermore, components in the first exemplary embodiment may be combined to create another exemplary embodiment.

Another exemplary embodiment will now be described as follows.

In the first exemplary embodiment, processor 102 stores the data of input files intact to pack file 213. Alternatively, however, processor 102 may compress the data of input files (reduce the data size) before storing it to pack file 213. This enables a larger amount of data to be recorded into optical disc 114.

When processor 102 compares the data size of pack file 213 with the first threshold, it is preferable that the compressed data should be used to calculate the data size of pack file 213. This achieves further efficient data recording.

Processor 102 may use different compression algorithms for different pack files. In this case, the type of a file to be input can be previously selected for each pack file, and a different compression process can be used according to the type of the file. For example, a pack file containing only text data can be reduced in data size by compression process. Meanwhile, moving or still image data may not be greatly reduced in data size by compression process. Therefore, pack files with such data does not necessarily have to be subjected to compression process.

Alternatively, processor 102 may use the same compression algorithm and different parameters (conditions) in setting the algorithms for different pack files. This reduces the number of types of the compression algorithms to be prepared by data recording system 100 and can generate pack files under different conditions. For example, an algorithm with a parameter that gives high priority to the compression rate is used for pack files that are to have a high compression rate. Meanwhile, an algorithm with a parameter that gives higher priority to the processing speed than to the compression rate is used for pack files that are to have a high-speed data reading and writing. Thus, pack files can be generated according to their conditions.

When a compression algorithm is used to generate a pack file, second threshold 302 is particularly important for the following reason. Since the size of an input file changes before and after compression process, it is difficult to predict how much the size of the pack file will increase before storing (adding) a new input file to it. However, providing second threshold 302 makes it relatively easy to determine whether adding a new input file to the pack file is possible.

In the first exemplary embodiment, second threshold 302 is substantially twice first threshold 301, but the scope of the present disclosure is not limited to this. For example, second threshold 302 relative to first threshold 301 can be determined based on the type of an input file, such as a text file, a moving-image file, or data file.

The first exemplary embodiment has described a data recording method, but the scope of the present disclosure is not limited to this. For example, the present disclosure can be applied to a device for recording data into a medium.

To achieve the data recording device, the flowchart (program) of FIG. 4 can be implemented by processor 102 or controller 111 shown in FIG. 1.

Thus, the present disclosure has been described in detail by taking the first exemplary embodiment as its example with reference to the accompanying drawings.

Note that some of the components described in detail and shown in the accompanying drawings are not essential components for the present disclosure, and should not be regarded as essential components just because they are described in detail and shown in the accompanying drawings.

The above-described exemplary embodiment exemplifies the techniques of the present disclosure. Therefore, various modification, replacement, addition, and omission can be made within the range of the claims and their equivalents.

### INDUSTRIAL APPLICABILITY

The present disclosure is industrially applicable as a method or device for recording data into a recording medium.

### REFERENCE MARKS IN THE DRAWINGS

100 data recording system

101 personal computer (PC)

102 processor

103 memory

104 hard disk

105 interface

110 optical disc drive

111 controller

112 memory

113 optical head

114 optical disc

115 interface

205 data of file 1

206 file system management information for file 1

207 data of file 2

208 file system management information for file 2

209 data of file 3

210 file system management information for file 3

211 data of file N

212 file system management information for file N

213 pack file

214 data of pack file 213

215 file system management information for pack file 213

216 management file

217 data of management file 216

218 file system management information for management file 216

301 first threshold

302 second threshold

What is claimed is:

1. A data recording method comprising:
selecting a first file from a plurality of input files and storing data of the first file into a pack file created based on a file system on a recording medium;
generating a management file and storing management information of the first file on the pack file into the management file; and
recording both the pack file containing the data of the first file and the management file containing the management information of the first file into the recording medium.

2. The method according to claim 1, wherein when a data size of the pack file is less than a first threshold,
the selecting step comprises selecting a second file from the plurality of input files and storing data of the second file into the pack file, and
the generating step comprises storing management information of the second file into the management file.

3. The method according to claim 2, wherein when the data of the second file has been completely stored into the pack file, if the data size of the pack file is not less than the first threshold and is less than a second threshold greater than the first threshold, then the recording step is performed.

4. The method according to claim 1, wherein when a data size of the pack file is not less than a first threshold, the selecting step stores the data of the first file alone into the pack file.

5. The method according to claim 1, wherein the selecting step comprises compressing the data of the first file before or during storing the data into the pack file.

6. The method according to claim 1, further comprising:
storing directory structure information of the plurality of input files as file system management information for the pack file.

7. The method according to claim 1, further comprising:
storing directory structure information of the plurality of input files into the management file corresponding to the pack file.
